(19) United States
(12) Patent Application Publication
(10) Pub. No.: US 2023/0102343 A1
(43) Pub. Date: Mar. 30, 2023

(54) ADDITIVE MANUFACTURING OF SUPPORT STRUCTURES HAVING IDENTIFIERS

(71) Applicant: Hewlett-Packard Development Company, L.P., Spring, TX (US)

(72) Inventors: Wei Huang, Palo Alto, CA (US); Gary J. Dispoto, Palo Alto, CA (US)

(73) Assignee: Hewlett-Packard Development Company, L.P., Spring, TX (US)

(21) Appl. No.: 17/911,382

(22) PCT Filed: Mar. 26, 2020
(86) PCT No.: PCT/US2020/025031

§ 371 Date: Sep. 13, 2022

(51) Int. Cl. G05B 19/4099

(52) U.S. Cl. CPC G05B 19/4099; G05B 2219/49023

(57) ABSTRACT

In some examples, a method comprises obtaining, by an additive manufacturing device, a file compatible with the additive manufacturing device, the file comprising representations of objects and a support structure for the objects, the representation of the support structure having an identifier for identifying the support structure; and the additive manufacturing device using an additive manufacturing process and the file to manufacture the objects, the support structure, and the identifier for identifying the support structure.

### BACKGROUND

Additive manufacturing allows for the manufacture of three-dimensional (3D) objects from an image file converted to a file format compatible with an additive manufacturing device. The image file comprises a model of the 3D objects. In some instances, the 3D objects may be components of a larger 3D object or a mold or a form to manufacture another 3D object. The image file is converted to a print file compatible with the additive manufacturing device. Following instructions of the print file, the additive manufacturing device performs an additive process to manufacture the 3D object. During the additive process, successive layers of material are laid down in accordance with instructions of the print file. Once the additive process is complete, post-processing may be performed on the manufactured 3D objects. Post-processing may include cleaning and finishing processes.

### BRIEF DESCRIPTION OF THE DRAWINGS

Various examples will be described below referring to the following figures:

FIG. 1 is an image file in accordance with various examples;

FIG. 2 is a schematic diagram of part of a system for manufacturing a support structure having an identifier, in accordance with various examples;

FIG. 3 is a schematic diagram of part of a system for manufacturing a support structure having an identifier, in accordance with various examples; and

FIG. 4 is a flow chart of a method for manufacturing a support structure having an identifier, in accordance with various examples.

### DETAILED DESCRIPTION

As discussed above, following instructions of a print file, an additive manufacturing device performs an additive process to manufacture a 3D object. The additive manufacturing device may be any additive manufacturing device utilizing an additive process. The additive process may be any additive process, such as vat photopolymerization (e.g., stereolithography (SLA), digital light processing (DLP)), direct metal laser sintering (DMLS), selective laser sintering (SLS), selective laser melting (SLM), electron-beam melting (EBM), selective heat sintering (SHS), LaserProFusion, binder jetting, material jetting, or any other additive process that utilizes a print file created from an image file.

Since the time-cost per layer of additive manufacturing does not increase by increasing a number of objects manufactured from an image file, multiple objects may be grouped together in the image file to improve efficiency. Additionally, to improve handling of objects during post-processing (e.g., cleaning, finishing) or after post-processing, small objects may be grouped together in the image file and joined by an image of a support structure. The grouped objects may be the same, may contain variations, or may be unrelated. By allowing different or unrelated objects and small objects to be grouped together by a support structure, additional manufacturing cycles may be avoided, thereby reducing overall costs. However, due to sizes of the objects or possible functional impairment of the objects, it may be impractical or infeasible to place distinguishing identifiers on the individual objects. Thus, during post-processing, it may be difficult to distinguish one object from another object, increasing time costs for handling associated with post-processing.

This disclosure describes a method for generating object identifiers for objects manufactured from grouped images of objects in an image file. As discussed above, the image file comprises a 3D model of the grouped images of objects. Each image of the grouped images of objects is a 3D model of an object. The object identifiers for objects manufactured from the grouped images of objects are based on identifiers for support structures associated with the grouped images of objects. To overcome the challenges of manufacturing object identifiers on an object, the grouped images of objects are associated with an image of a support structure. The image of the support structure may be of any structure that can affix to or enclose the grouped images of objects (e.g., rod, frame, lattice, polyhedron, or some combination thereof). The image of the support structure may comprise multiple support members. The image of the support structure may comprise multiple planar layers of grouped images of objects. Each planar layer of the multiple planar layers may comprise an image of a different support structure.

The image of the support structure for the grouped objects is assigned an identifier for identifying the support structure. The identifier for identifying the support structure may comprise a symbol, a letter, a number, an alphanumeric sequence, or a combination thereof. The identifier for identifying the support structure may be randomly generated or may be based, in whole or in part, on a product identifier (e.g., batch number, order number, group number). The identifier for identifying the support structure corresponds to a predetermined location on the image of the support structure. The resulting image file comprises grouped images of objects, an image of the support structure for the objects, and the identifier for identifying the support structure. In some examples, at least one orientation indicator corresponding to another predetermined location on the image of the support structure may be assigned to the image of the support structure. The orientation indicator may comprise a letter, a number, or a symbol, such as an arrow, geometric shape, or any other mark, for example.

An object identifier may be generated for an object of the grouped images of objects based on the identifier for identifying the support structure, the predetermined location of the identifier for identifying the support structure, the at least one orientation indicator, the another predetermined location corresponding to the at least one orientation indicator, the location of the object relative to the predetermined location of the identifier for identifying the support structure, the location of the object relative to the another predetermined location corresponding to the at least one orientation indicator, or some combination thereof. The object identifiers are stored in a data structure. As used herein, a data structure is an object that stores and cross-references data (e.g., a lookup table, database).

The image file is converted to a print file having a format compatible with an additive manufacturing device. As discussed above, following instructions of the print file, the additive manufacturing device performs an additive process to manufacture the 3D objects and associated support structure, the support structure having the identifier for identifying the support structure in the predetermined location. A person or computing device may then utilize the identifier for identifying the support structure in conjunction with the stored object identifiers to determine which post-processing techniques to utilize on an object or where to deliver an object. By manufacturing the support structure having the identifier for identifying the support structure, a variety of objects may be manufactured in a single batch and assigned object identifiers, reducing costs, increasing efficiencies, and facilitating post-manufacturing processing

In an example in accordance with the present disclosure, a method is provided. The method comprises obtaining, by an additive manufacturing device, a file compatible with the additive manufacturing device, the file comprising representations of objects and a support structure for the objects, the representation of the support structure having an identifier for identifying the support structure; and the additive manufacturing device using an additive manufacturing process and the file to manufacture the objects, the support structure, and the identifier for identifying the support structure.

In another example in accordance with the present disclosure, a non-transitory computer-readable medium is provided. The non-transitory computer-readable medium stores machine-readable instructions which, when executed by a processor, cause the processor to group images of objects for additive manufacturing; generate an image of a support structure for the grouped images of objects; generate an identifier for identifying the support structure, the identifier corresponding to a predetermined location on the image of the support structure; and generate an image file comprising the grouped images of objects and the image of the support structure, wherein a print file compatible with an additive manufacturing device and based on the image file causes the additive manufacturing device to manufacture the objects and the support structure for the objects, the support structure having the identifier for identifying the support structure on the predetermined location of the support structure.

In yet another example in accordance with the present disclosure, a system is provided. The system comprises a storage device comprising machine-readable instructions and a processor coupled to the storage device. Execution of the machine-readable instructions causes the processor to generate an image of a support structure for an image of an object; generate an identifier for identifying the support structure, the identifier corresponding to a predetermined location on the image of the support structure; and generate an image file comprising the image of the object and the image of the support structure, wherein the image file, when converted to a print file compatible with an additive manufacturing device, is usable by the additive manufacturing device to manufacture the object and the support structure for the object, the identifier positioned on an area of the support structure corresponding to the predetermined location on the image of the support structure.

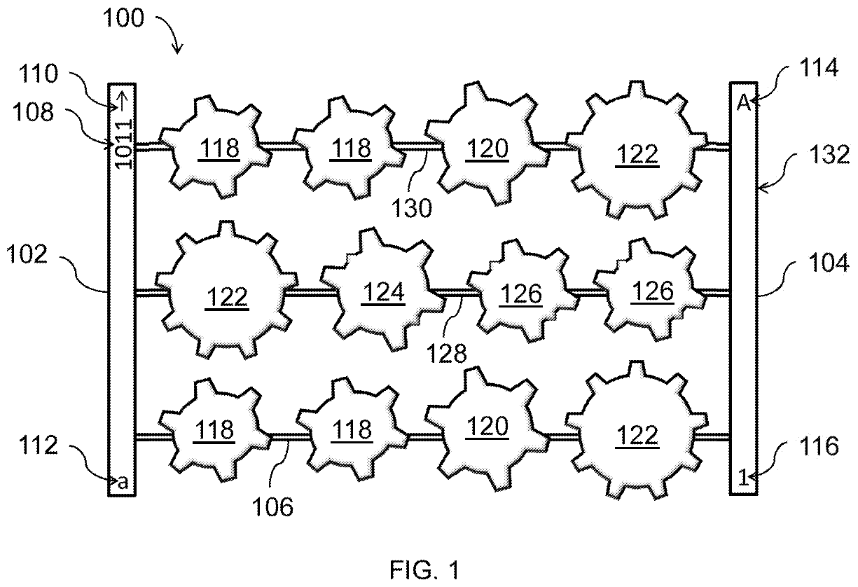

FIG. 1 is an image file 100 in accordance with various examples. The image file 100 comprises images, or models, of 3D objects 118, 120, 122, 124, and 126 and an image of a support structure 132 comprising support members 102, 104, 106, 128, 130. The support member 102 comprises predetermined locations 108, 110, and 112. The support member 104 comprises predetermined locations 114 and 116. The predetermined location 108 is labeled with an identifier of “1011.” As discussed above, the identifier for identifying the support structure may comprise a symbol, a letter, a number, an alphanumeric sequence, or a combination thereof. The identifier for identifying the support structure may comprise a bar code symbol of an alphanumeric sequence, for example. The identifier for identifying the support structure may be randomly generated or may be based, in whole or in part, on a product identifier, such as a batch number, order number, group number, or any other suitable symbolic or alphanumeric identifier, for example.

As discussed above, the orientation indicator may include a letter, a number, or a symbol, such as an arrow, geometric shape, or any other suitable mark, for example. The orientation indicator may correspond to a predetermined location 110, 112, 114, 116 on the image of the support structure 132, for example. The orientation indicator may be sized and shaped to be detectable by a human eye or by a computing device prior to post-processing. For example, the predetermined location 110 labeled with an orientation indicator of an arrow pointing away from the predetermined location 108 may be detectable prior to cleaning the support structure 132. In an example, the arrow may indicate a directional orientation of the image of the support structure 132. In another example, the arrow may indicate an image of an object nearest in proximity to the arrow is an image of a first object associated with the image of the support structure 132. The predetermined location 112 is labeled with an orientation indicator of “a.” The “a” may indicate the support member 102 is a first support member of the image of the support member 132 when the image file 100 comprises images of multiple support members and the support member 132 shares a support member with at least one other support member of the multiple support members, for example.

The predetermined location 114 has an orientation indicator of “A.” The “A” may indicate the support member 104 is a first support member of the image of the support structure 132, for example. In another example, the “A” may indicate the image of the support structure 132 is an image of a first support structure of images of multiple support structures of the image file 100, where the multiple support structures share a feature (e.g., same objects, objects to be assembled into a larger object, objects to be shipped to a same customer). In yet another example, the “A” may indicate the support member 130 nearest in proximity to the “A” comprises an image of a first object associated with the image of the support structure 132. The predetermined location 116 has an orientation indicator of “1.” The “1” may indicate the image of the support structure 132 is a first planar layer of an image of a larger support structure of the image file 100, for example.

In some examples, the predetermined locations 108, 110, 112, 114, 116 may be fewer in number, may be located on a different combination of the support members 102, 104, 106, 128, 130, or some combination thereof. In other examples, additional predetermined locations may be labeled with the identifier for identifying the support structure, an orientation indicator, or some combination thereof. In various examples, the identifier for identifying the support structure may be located on a support member having no orientation indicator. For example, the identifier for identifying the support structure may be located on a predetermined location of support member 130 instead of support member 108 while predetermined locations 110, 114, 116 remain labeled as in FIG. 1.

The image of the support structure 132 couples to the images of objects 118, 120, 122, 124, 126. The image of the support structure 132 may be coupled to non-functional surfaces or invisible surfaces of the images of objects 118, 120, 122, 124, 126. A non-functional surface of an object is a surface that is not utilized when the object is used for its intended function. For example, the outward projections forming an outer diameter of the images of objects 118, 120, 122, 124, 126 may be teeth of gears. The teeth may engage with teeth of other objects. Thus the teeth are the functional surfaces of the images of objects 118, 120, 122, 124, 126. The non-functional surfaces of the images of objects 118, 120, 122, 124, 126 may be the surfaces that from an inner diameter of the images of objects 118, 120, 122, 124, 126, for example. An invisible surface of an object is a surface that is not visible when the object is used for its intended function. Continuing the previous example in which the outward projections of the images of objects 118, 120, 122, 124, 126 are teeth of gears, if front surfaces of the gears are visible when the teeth engage, then the image of the support structure 132 may couple to back surfaces of the images of objects 118, 120, 122, 124, 126.

In some examples, the image of the support structure 132 is optimized in structure and thickness to facilitate removal of manufactured objects from the support structure. In other examples, the image of the support structure 132 is optimized in structure and thickness to reduce a footprint utilized to attach to the images of objects 118, 120, 122, 124, 126 by the image of the support structure 132. In various examples, the image of the support structure 132 affixed to the grouped images of objects 118, 120, 122, 124, 126 may form a planar layer and multiple planar layers may be enclosed in an image of a larger support structure. In other examples, the image of the support structure 132 may surround or enclose the images of objects 118, 120, 122, 124, 126 without coupling to the images of objects 118, 120, 122, 124, 126. For example, the images of objects 118, 120, 122, 124, 126 may be enclosed in an image of cage-like support structure (e.g., a polyhedron having latticed faces).

Because the images of objects 118, 120, 122, 124, 126 are associated with the image of the support structure 132, the images of objects 118, 120, 122, 124, 126 may be said to be grouped images of objects. The images of objects 118, 120, 122, 124, 126 may be grouped together based on any number of factors, such as increasing efficiencies or facilitating post-manufacturing processing. For example, the images of objects 118, 120, 122, 124, 126 may be grouped to optimize a number of objects manufactured in a batch or to reduce an amount of waste material associated with the batch. In another example, the images of objects 118, 120, 122, 124, 126 may be grouped because the manufactured objects are assembled into a larger object. In yet another example, the images of objects 118, 120, 122, 124, 126 may be grouped because the manufactured objects have a same customer.

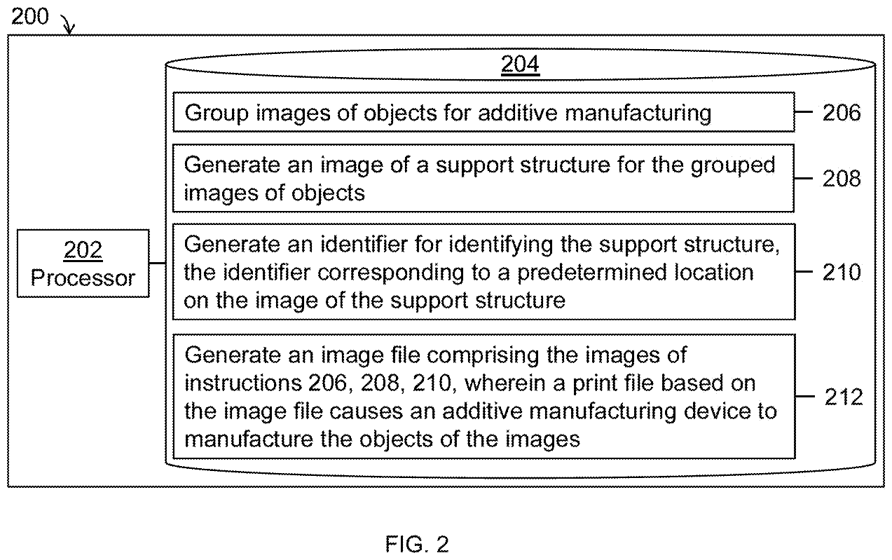

FIG. 2 is a schematic diagram of part of a system 200 for manufacturing a support structure having an identifier, in accordance with various examples. The system 200 comprises a processor 202 and a computer-readable medium 204. The system 200 may comprise a computing device (e.g., a laptop, a notebook, a tablet, a smartphone, a mobile device, or any other electronic device such as an additive manufacturing device having a processor) or a network of computing devices (e.g., local area network (LAN), wide area network (WAN), virtual private network (VPN), client/server network, Internet (e.g., cloud), or any other suitable system for sharing processing and memory resources). The computer-readable medium 204 is a non-transitory medium that stores machine-readable instructions. The computer-readable medium 204 may comprise a storage device such as a hard drive, solid state drive (SSD), flash memory, random access memory (RAM), or other suitable memory, for example. The computer-readable medium 204 may be local to a computing device or may be on a remotely managed storage device (e.g., enterprise cloud, public cloud, data center, server, or any other suitable storage device). The processor 202 may comprise a microprocessor, a microcomputer, a microcontroller, or another suitable embedded controller, for example. The processor 202 may be local to the computing device comprising the computer-readable medium 204 or may be on a remotely managed computing device (e.g., server, central server, edge server, or any other suitable computing device). The computer-readable medium 204 may store machine-readable instructions, which, when executed, cause the processor 202 to perform some or all of the actions attributed herein to the system 200.

The computer-readable medium 204 comprises machine-readable instructions 206, 208, 210, and 212. The machine-readable instructions 206, 208, 210, 212 may be machine-readable instructions for execution by the processor 202. Execution of the machine-readable instructions 206, 208, 210, 212 may cause the processor 202 to generate an image file comprising grouped images of objects and an image of a support structure for the grouped images of objects. Execution of machine-readable instruction 206 may cause the processor 202 to group images of objects for additive manufacturing. Execution of machine-readable instruction 208 may cause the processor 202 to generate an image of a support structure for the grouped images of objects. Execution of machine-readable instruction 210 may cause the processor 202 to generate an identifier for identifying the support structure, the identifier corresponding to a predetermined location on the image of the support structure. Execution of machine-readable instruction 212 may cause the processor 202 to generate an image file comprising the grouped images of instructions 206, 208, and 210, where the image file, when converted to a file format compatible with an additive manufacturing device, causes the additive manufacturing device to manufacture the objects of the image file.

The images of objects grouped for additive manufacturing as a result of the processor 202 executing machine-readable instruction 206 may be the grouped images of objects 118, 120, 122, 124, 126, for example. The image of the support structure generated as a result of the processor 202 executing machine-readable instruction 208 may be the image of the support structure 132, for example. The identifier for identifying the support structure generated as a result of the processor 202 executing machine-readable instruction 210 may be the identifier “1011” for identifying the support structure 132, the identifier located at the predetermined location 108, for example. The image file generated as a result of the processor 202 executing machine-readable instruction 212 may be the image file 100, for example.

In some examples, the image of an object is a scan of a 3D object. In other examples, the image of an object is a model available from a third-party. In yet other examples, the image of an object is a model created by a user utilizing machine-readable instructions of a computing device. As discussed above with respect to FIG. 1, the grouped images of objects may be grouped together by the processor 202 based on any number of factors, such as increasing efficiencies or facilitating post-manufacturing processing.

In various examples, a shape of image of the support structure may be determined by the processor 202 based on any number of factors, such as increasing efficiencies or facilitating post-manufacturing processing. The shape may be a rod, a frame, a lattice, a polyhedron, or some combination thereof, for example. In some examples, the processor 202 may generate an image of a first support structure having a first shape for a first set of grouped images of objects and generate an image of a second support structure having a second shape for a second set of grouped images of objects. For example, the processor 202 may generate an image of a first support structure having a cube shape for a first set of grouped images of objects and generate an image of a second support structure having a box shape for a second set of grouped images of objects.

In various examples, the identifier for identifying the support structure may correspond to a predetermined location on the image of the support structure. The processor 202 may determine the predetermined location to facilitate object identification. For example, the processor 202 may determine the predetermined location based on a support member of the image of the support structure having a sufficient surface area to allow the identifier for identifying the support structure to be detectable by a human eye or by a computing device. In another example, the processor 202 may determine the predetermined location based on a number of images of support structures in the image file. For example, if the image file comprises a dozen images of support structures, the processor 202 may determine the predetermined location for the identifier for identifying a support structure of the dozen support structures is located on a left-most support member of each image of a support structure of the dozen support structures. In yet another example, the processor 202 may determine the predetermined location based on a complexity (e.g., number of faces, number of planar layers, number of support members, whether faces comprise gaps) of the shape of the image of the support structure.

In other examples, the processor 202 may convert the image file to a print file compatible with an additive manufacturing device. As discussed above, following the instructions of the print file, the additive manufacturing device performs an additive process to manufacture the objects and the support structure for the objects, the support structure having the identifier for identifying the support structure on the predetermined location of the support structure. The processor 202 may convert the image file to a print file having an additive manufacturing file format (AMF), a stereolithography file format (STL), or a 3D manufacturing file format (3MF), for example. In some examples, the conversion of the image file to a file format compatible with an additive manufacturing device may result in the creation of multiple files. For example, the processor 202 may create a first print file describing the surfaces of the objects in geometric terms, a second print file describing a material or materials of the objects, a third print file describing a color distribution of the objects, or some combination thereof.

In some examples, the processor 202 may generate an orientation indicator corresponding to another predetermined location on the image of the support structure. The orientation indicator generated by the processor 202 may be the orientation indicator “A” located at the predetermined location 114, for example. In various examples, the processor 202 may generate multiple orientation indicators, an orientation indicator of the multiple orientation indicators corresponding to a different predetermined location on the image of the support structure. For example, the multiple orientation indicators generated by the processor 202 may be the orientation indicators of the arrow pointing away from the identifier for identifying the support structure at the predetermined location 108 and of the “1” at the predetermined location 116. The processor 202 may determine the another predetermined location corresponding to the orientation indicator to facilitate object identification. For example, the processor 202 may determine the another predetermined location corresponding to the orientation indicator based on a support member of image of the support structure having a sufficient surface area to allow the orientation indicator to be detectable by a human eye or by a computing device. In another example, the processor 202 may determine the another predetermined location corresponding to the orientation indicator based on a number of support members of the image of the support structure. In yet another example, the processor 202 may determine the another predetermined location based on a relationship (e.g., whether objects are same, whether objects are parts of a larger object, whether objects are for a same customer) among images of multiple support structures within the image file.

As discussed above, an object identifier may be generated for an object of the grouped images of objects utilizing the identifier for identifying the support structure, a location of the object relative to the predetermined location of the identifier for identifying the support structure, at least one orientation indicator corresponding to another predetermined location on the image of the support structure, the location of the object relative to the predetermined location of the identifier, the location of the object relative to the another predetermined location corresponding to the at least one orientation indicator, or some combination thereof. Which combination is utilized by the processor 202 to generate the object identifier may be determined by a complexity of the shape of image of the support structure, a number of images of support structures in the image file, or whether grouped images of objects share features (e.g., same objects, objects to be assembled into a larger object, objects to be shipped to a same customer), or some combination thereof, for example. For example, if objects manufactured based on an image file are destined for the same customer, the object identifiers for the grouped images of objects in the image file may utilized the identifier for identifying the support structure, where the identifier is based on an order number. The processor 202 may store the object identifiers in a data structure stored on the computer-readable medium 204, for example.

Referring briefly to FIG. 1, the processor 202 may generate an object identifier of “1011_1” for the image of the object 118 located nearest, or most proximate to, the identifier for identifying the support structure 132, where “1011” indicates the identifier for identifying the support structure 132 associated with the object 118 and “1” indicates a position of the image of the object 118 relative to the identifier “1011” on the image of the support structure 132, for example. In another example utilizing FIG. 1, the processor 202 may generate an object identifier of “1101_A_4” for the image of the object 122 located nearest the orientation indicator labeled “A” on the support member 104, where “1011” indicates the identifier for identifying the support structure 132 associated with the object 122, “A” indicates the orientation indicator “A” on the support member 104, and “4” indicates the position of image of the object 122 relative to the predetermined location 108 of the identifier for identifying the support structure 132. In yet another example utilizing FIG. 1, the processor 202 may generate an object identifier of “1101_A_1_2_3” for the image of the object 126 located nearest the identifier “1011” for identifying the support structure 132, where “1011” indicates the identifier for identifying the support structure 132 associated with the image of the object 122, “A” indicates the orientation indicator “A” on the support member 104, “1” indicates the orientation indicator corresponding to the predetermined location 116 on the support member 104, “2” indicates a position of the horizontal support member to which the object 122 is coupled relative to the predetermined location 110 of the orientation indicator that is an arrow pointing away from the identifier “1011”, and “3” indicates the position of the object 122 relative to the predetermined location 110 of the orientation indicator that is an arrow pointing away from the identifier “1011.”

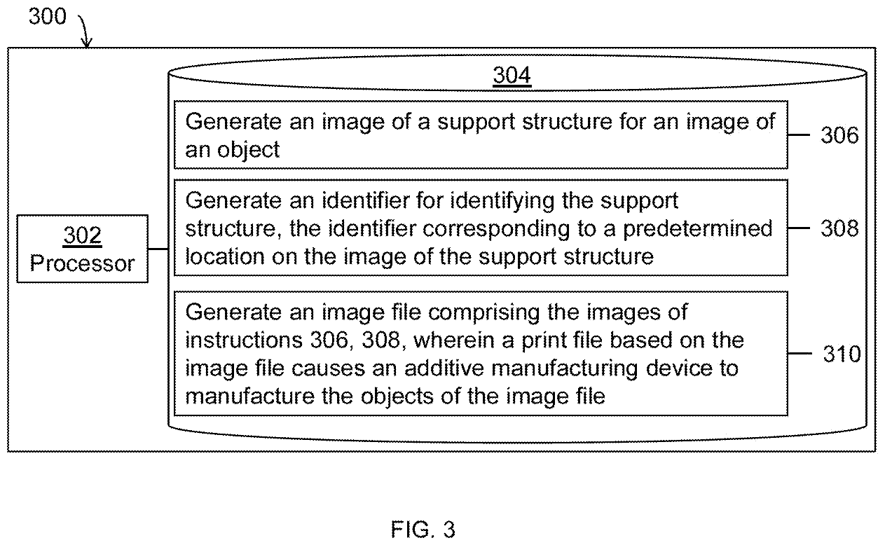

Referring now to FIG. 3, a schematic diagram of part of a system 300 for manufacturing a support structure having an identifier is presented, in accordance with various examples. The system 300 comprises a processor 302 and a storage device 304. The system 300 may be the system 200, for example. The processor 302 may be the processor 202, for example. The storage device 304 may be the computer-readable medium 204, for example. The storage device 304 may store machine-readable instructions, which, when executed, cause the processor 302 to perform some or all of the actions attributed herein to the system 300.

The storage device 304 comprises machine-readable instructions 306, 308, and 310. The machine-readable instructions 306, 308, 310 may be machine-readable instructions for execution by the processor 302. Execution of the machine-readable instructions 306, 308, 310 may cause the processor 302 to generate an image file comprising an image of an object and an image of a support structure for the image of the object. Execution of machine-readable instruction 306 may cause the processor 302 to generate an image of the support structure for an image of an object. Execution of machine-readable instruction 308 may cause the processor 302 to generate an identifier for identifying the support structure, the identifier corresponding to a predetermined location on the image of the support structure. Execution of machine-readable instruction 310 may cause the processor 302 to generate an image file comprising the images of machine-readable instructions 306, 308 and that, when converted to a file format compatible with an additive manufacturing device, causes the additive manufacturing device to manufacture the objects of the image file.

As discussed above with respect to FIG. 2, an image file may comprise images of a number of support structures. For example, the processor 302 may generate an image file comprising images of numerous support structures, each image of the numerous support structures having a shape of a hexagonal cell. Each image of a hexagonal cell may comprise an image of a different object. In various examples, the processor 302 may generate an identifier for identifying each hexagonal cell, each identifier corresponding to a predetermined location of each image of a hexagonal cell. In other examples, the processor 302 may generate an identifier for identifying multiple hexagonal cells and an orientation indicator for each hexagonal cell of the multiple hexagonal cells. For example, the image file may comprise seven hexagonal cells, a central hexagonal cell with the remaining six hexagonal cells each coupled to a different face of the central hexagonal cell. Each hexagonal cell of the seven hexagonal cells may comprise an image of a same object. The processor 302 may generate an identifier for the central hexagonal cell and an orientation indicator for each hexagonal cell of the remaining six hexagonal cells, for example. In another example, the processor 302 may generate an identifier for the central hexagonal cell and an orientation indicator for each hexagonal cell of the seven hexagonal cells.

As discussed above with respect to FIG. 2, a shape of image of the support structure may be determined based on any number of factors, such as increasing efficiencies and facilitating post-manufacturing processing. For example, to maximize a number of objects for manufacturing, the processor 302 may generate an image of a first support structure that is a polyhedron having a first number of faces and generate an image of a second support structure that is a polyhedron having a second number of faces. In another example, to accommodate different grouped images of objects, the processor 302 may generate an image of a first support structure that is a polyhedron having solid faces for a first set of the different grouped images of objects and generate an image of a second support structure that is a polyhedron having faces with gaps (e.g., latticed) for a second set of the different grouped images of objects.

In various examples, when the image file comprises images of numerous support structures, at least two support structures of the numerous support structures may share a support member. In some examples, the processor 302 may generate an identifier for identifying a first support structure of the at least two support structures sharing a support member, the identifier for identifying the first support structure corresponding to a predetermined location of the shared support member. When the processor 302 generates an object identifier for an object of grouped images of objects of the first support structure of the at least two support structures sharing a support member, the processor 302 utilizes the identifier corresponding to the predetermined location of the shared support member. The processor 302 may store the object identifiers in a data structure stored on the storage device 304, for example.

Referring briefly to FIG. 1, the processor 302 may generate an object identifier of “1011_1” for the image of the object 118 located nearest, or most proximate to, the identifier for identifying the support structure 132, where “1011” indicates the identifier for identifying the support structure 132 associated with the object 118, and “1” indicates a position of the image of the object 118 relative to the identifier “1011” on the image of the support structure 132, for example. The processor 302 may generate an object identifier of “1012_1” for an image of an object associated with the another support member sharing the support member 102, for example.

Referring to FIG. 3, in other examples, the processor 302 may generate an identifier for identifying the at least two support structures sharing a support member, the identifier corresponding to a predetermined location of the shared support member. In various examples, when the image file comprises images of numerous support structures and at least two support structures of the numerous support structures share a support member, the processor 302 may generate an orientation indicator for the first support structure of the at least two support structures sharing a support member, the orientation indicator corresponding to another predetermined location of the shared support member. When the processor 302 generates an object identifier for an object of grouped images of the first support structure of the at least two support structures sharing a support member, the processor 302 may utilize an identifier corresponding to the predetermined location of the shared support member, the at least one orientation indicator corresponding to another predetermined location of the shared support member, or some combination thereof to generate the object identifier.

Referring briefly to FIG. 1, the processor 302 may generate an object identifier of “1011a_1” for the image of the object 118 located nearest, or most proximate to, the identifier for identifying the support structure 132, where “1011” indicates the identifier for identifying the support structure 132 associated with the object 118, “a” indicates the support member 102 is shared with another support member of the image file 100, and “1” indicates a position of the image of the object 118 relative to the identifier “1011” on the image of the support structure 132, for example. The processor 302 may generate an object identifier of “1011b_1” for an image of an object associated with the another support member sharing the support member 102, for example.

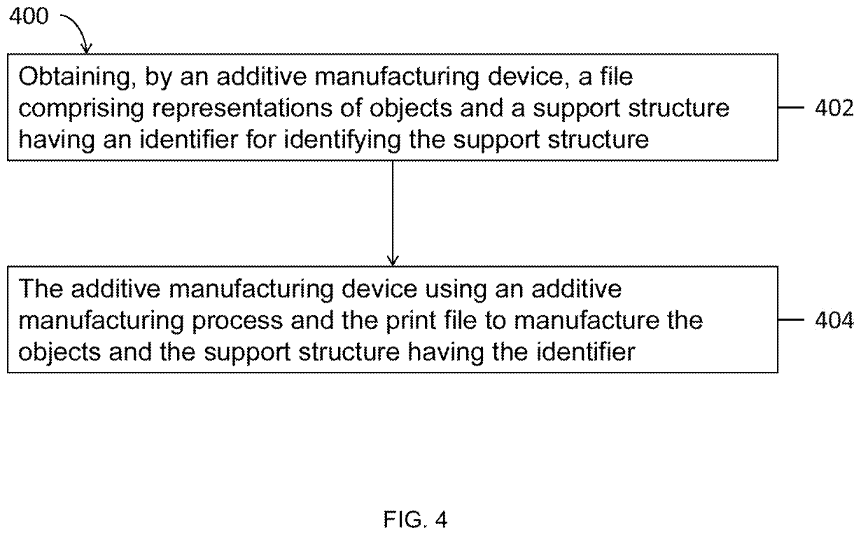

Referring to FIG. 4, a flow chart of a method 400 for manufacturing a support structure having an identifier is presented, in accordance with various examples. The method 400 includes obtaining, by an additive manufacturing device, a file compatible with the additive manufacturing device, the file comprising representations of objects and a support structure, the support structure having an identifier for identifying the support structure (402). The method 400 also includes the additive manufacturing device using an additive manufacturing process and the file to manufacture the objects, the support structure, and the identifier for identifying the support structure (404).

In some examples, the file of the method 400 comprises representations of multiple groups of objects, each group associated with a representation of a support structure for the grouped objects. In various examples, the file of the method 400 comprises representations of objects, the representation of the support structure for the objects, the representation of the support structure having an identifier for identifying the support structure at a predetermined location on the representation of the support structure and having at least one orientation indicator corresponding to another predetermined location on the representation of the support structure.

After manufacturing the objects, the support structure, and the identifier for identifying the support structure, the objects may be identified utilizing the data structure of object identifiers. For example, a person or a computing device may utilize the identifier for identifying the support structure, the location of the identifier for identifying the support structure, at least one orientation indicator, a location corresponding to the at least one orientation indicator, the location of the object relative to the location of the identifier for identifying the support structure, the location of the object relative to the location of the at least one orientation indicator, or some combination thereof to compare to an object identifier of the data structure. Based on a result of the comparison, the person or the computing device may determine an identity of an object of the manufactured objects.

In some examples, after manufacture, the objects may be identified to determine post-processing techniques to be performed on the objects. In other examples, after manufacture, the objects are subjected to a number of post-processing techniques, such as rough cleaning, sandblasting, and water-jetting. After the number of post-processing techniques are performed, the objects may be sorted for additional post-processing. For example, the objects may be removed from their associated support structure and grouped with objects that are the same, but associated with a different support structure. In some examples, the different support structure may be manufactured in a same batch as the objects removed from their associated support structure. In other examples, the different support structure may be manufactured in a different batch as the objects removed from their associated support structure.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the above discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.”

What is claimed is:

1. A method, comprising:
obtaining, by an additive manufacturing device, a file compatible with the additive manufacturing device, the file comprising representations of objects and a support structure for the objects, the representation of the support structure having an identifier for identifying the support structure; and
the additive manufacturing device using an additive manufacturing process and the file to manufacture the objects, the support structure, and the identifier for identifying the support structure.

2. The method of claim 1, wherein the identifier for identifying the support structure corresponds to a predetermined location of the support structure.

3. The method of claim 1, wherein the support structure comprises a plurality of support members, at least one support member of the plurality of support members having an orientation indicator corresponding to a predetermined location of the support structure.

4. The method of claim 3, wherein the identifier for identifying the support structure is located on a support member of the plurality of support members different than the at least one support member having the orientation indicator.

5. The method of claim 3, wherein the at least one support member having the orientation indicator comprises the identifier for identifying the support structure.

6. A non-transitory computer-readable medium storing machine-readable instructions which, when executed by a processor, cause the processor to:
group images of objects for additive manufacturing;
generate an image of a support structure for the grouped images of objects;
generate an identifier for identifying the support structure, the identifier corresponding to a predetermined location on the image of the support structure; and
generate an image file comprising the grouped images of objects and the image of the support structure, wherein a print file compatible with an additive manufacturing device and based on the image file causes the additive manufacturing device to manufacture the objects and the support structure for the objects, the support structure having the identifier for identifying the support structure on the predetermined location of the support structure.

7. The non-transitory computer-readable medium of claim 6, wherein execution of the machine-readable instructions causes the processor to generate a data structure comprising a location of each object of the grouped images of objects based on the identifier for identifying the support structure.

8. The non-transitory computer-readable medium of claim 6, wherein execution of the machine-readable instructions causes the processor to generate at least one orientation indicator corresponding to another predetermined location on the image of the support structure.

9. The non-transitory computer-readable medium of claim 8, wherein execution of the machine-readable instructions causes the processor to generate a data structure comprising a location of each object of the grouped images of objects based on the at least one orientation indicator.

10. A system, comprising:
a storage device comprising machine-readable instructions; and
a processor coupled to the storage device, wherein execution of the machine-readable instructions causes the processor to:
generate an image of a support structure for an image of an object;
generate an identifier for identifying the support structure, the identifier corresponding to a predetermined location on the image of the support structure; and
generate an image file comprising the image of the object and the image of the support structure, wherein the image file, when converted to a print file compatible with an additive manufacturing device, is usable by the additive manufacturing device to manufacture the object and the support structure for the object, the identifier positioned on an area of the support structure corresponding to the predetermined location on the image of the support structure.

11. The system of claim 10, wherein the image file comprises an image of a first object associated with an image of a first support structure and an image of a second object associated with an image of a second support structure, each image of the first and second support structures comprising a different identifier for identifying the corresponding support structure.

12. The system of claim 11, wherein the images of the first and second support structures share a support member.

13. The system of claim 12, wherein the shared support member comprises an orientation indicator corresponding to another predetermined location on the image of the first support structure.

14. The system of claim 11, wherein the image of the first support structure and the image of the second support structure are polyhedrons, each polyhedron having a different number of faces.

15. The system of claim 10, wherein the additive manufacturing device is to use a process selected from the group consisting of a powder bed fusion process, a vat photopolymerization process, a binder jetting process, and a material jetting process.
